(19) United States
(12) Patent Application Publication
(10) Pub. No.: US 2012/0193513 A1
(43) Pub. Date: Aug. 2, 2012

(54) LASER SYSTEM FOR A MICROSCOPE AND METHOD FOR OPERATING A LASER SYSTEM FOR A MICROSCOPE

(75) Inventors: Bernd Widzgowski, Dossenheim (DE); Volker Seyfried, Nussloch (DE); Holger Birk, Meckesheim (DE)

(73) Assignee: LEICA MICROSYSTEMS CMS GMBH, Wetzlar (DE)

(21) Appl. No.: 13/500,160

(22) PCT Filed: Oct. 8, 2010
(86) PCT No.: PCT/EP2010/065071

§ 371 Date: Apr. 4, 2012

(30) Foreign Application Priority Data
Oct. 8, 2009 (DE) 102009048710.7

(51) Int. Cl. G01J 1/32

(52) U.S. Cl. 250/205

(57) ABSTRACT

The invention relates to a laser system (20) for a microscope, comprising a laser module (22), a beam correction device (26), an optical fiber (31), a measuring element (34), and an external controller (37). The laser module (22) generates a light beam (24). The light beam (24) penetrates the beam correction device (26), which corrects a deviation of an actual value of at least one parameter of the light beam (24) from a target value of the parameter. The corrected light beam (24) is coupled into the optical fiber (31). The measuring element (34) is connected downstream of the optical fiber (31) and captures an actual value (36) of the intensity of at least one partial beam (32) of the corrected light beam (24). The external controller (37), regulates the actual value (36) of the intensity to a prescribed target value for the intensity.

### CROSS REFERENCE TO RELATED APPLICATIONS

The present application is the U.S. National Stage of International Application No. PCT/EP2010/065071 filed Oct. 8, 2010, which claims priority of German Application No. 10 2009 048 710.7-56 filed Oct. 8, 2009. The present application claims priority benefit of said International Application No. PCT/EP2010/065071 and said German Application No. 10 2009 048 710.7-56.

### FIELD OF THE INVENTION

The invention relates to a laser system for a microscope. Moreover, the invention relates to a method for operating a laser system for a microscope.

### BACKGROUND OF THE INVENTION

Laser systems nowadays are used in all kinds of technological fields. The lasers are regularly used for lighting purposes in which precise, high intensity light sources in point form are required. In confocal microscopy, in particular, it is important that a light beam produced by the laser system, particularly an illuminating light beam of a confocal microscope, is particularly precise. In this context and hereinafter, the word precise means that if one or more actual values of one or more parameters of the light beam produced deviate from corresponding target values of the parameters, this deviation is as small as possible, preferably negligibly small. The parameter or parameters include, for example, polarisation, wavelength, beam quality and/or deviation of the light beam from a prescribed path. Moreover, in confocal microscopy, in particular, the stability of the intensity of the light beam is subject to particularly high demands. The actual intensity of the light beam should deviate as little as possible from a prescribed intensity.

These requirements are regularly taken into account by the manufacture of particularly expensive and complex laser systems with extremely precisely operating components.

The problem of the present invention is to provide a laser system for a microscope and a method of operating a laser system for a microscope which while achieving low manufacturing costs for the laser system make it possible to produce a particularly precise light beam and/or a light beam that is stable with regard to its intensity.

### SUMMARY OF THE INVENTION

According to a first aspect of the invention, the invention relates to a laser system having a laser module that produces a light beam. The light beam passes through a beam correction device which corrects a deviation of an actual value of at least one parameter of the light beam from a target value of the parameter. In one embodiment, the beam correction device is followed by an optical fibre and a measuring element, the optical fibre deflecting the corrected light beam onto the measuring element and the measuring element determining an actual value of the intensity of at least one partial beam of the corrected light beam. An external controller which is coupled to a power supply of the laser module and to the measuring element regulates the actual value of the intensity to a prescribed target value for the intensity.

When compensating the deviation of the actual value of the parameter from the target value of the parameter, the intensity of the light beam may be varied, particularly reduced. The use of the light beam in conjunction with the regulation of the intensity to the prescribed target value for the intensity contribute to the light beam being particularly stable in its intensity. The fact that the light beam is stable means, in this context, that the intensity of the light beam deviates particularly little, preferably not at all, from the prescribed target value for the intensity. The deviation also encompasses fluctuations in the corresponding actual value of the parameter by a different value. Moreover, the deviation also encompasses drift effects of the corresponding parameter value which occur for example as the result of temperature, ageing or wear of the laser system. The target value for the intensity is fixedly predetermined, for example, or determined by an application device that uses the laser system.

With the beam correction device it is possible, for example, to compensate deviations in the wavelength, polarisation, beam quality and/or beam position, i.e. the actual beam path of the light beam generated compared with a prescribed beam path. The optical fibre may also be regarded as an element of the beam correction device, particularly for correcting the beam path. This makes it possible to use relatively inexpensive components for the laser system, for example the laser module and/or the beam correction device, while still generating a light beam that is so precise and stable that the laser system can be used as a light source in a microscope, particularly in a confocal microscope.

The beam correction device comprises at least one and preferably several compensation elements. The compensation elements are, for example, a diaphragm, a pinhole, the optical fibre, a wavelength filter and/or a pole filter. The optical fibre is preferably embodied as a monomode glass fibre, the core diameter of the monomode glass fibre preferably being in the region of the wavelength of the light beam, as then the axial end of the optical fibre can be regarded as a point light source. The diaphragm and the optical fibre help to ensure that only minor and preferably no deviations occur in the beam path of the light beam. In particular, it is possible to ensure in this way that the actual beam path of the light beam corresponds to the prescribed beam path of the light beam. In addition, the pinhole and the optical fibre guarantee that the beam quality remains consistently high. The wavelength filter corrects deviations in wavelength and the pole filter corrects deviations in polarisation. The pinhole may help to increase the beam quality.

The laser module preferably comprises a semiconductor laser which includes for example a surface-emitting or edge-emitting laser diode.

In an advantageous embodiment the laser system comprises an internal controller. The internal controller regulates an actual value of the current through the semiconductor module to a target value for the current. The target values for the current are prescribed by the external controller.

According to a second aspect of the invention, the invention relates to a method for operating a laser system for a microscope. By means of a laser module the light beam is produced and any deviation of the actual value of at least one parameter of the light beam from a target value of the parameter is corrected. According to the second aspect the invention is characterised in that the corrected light beam is coupled into the optical fibre and then the actual value of the intensity of the corrected light beam is determined and with the aid of the power supply to the laser module the actual value of the intensity is regulated to the target value for the intensity.

The light intensity of the light source can then easily be modulated by predetermining the target value of the intensity dynamically, i.e. variably.

### BRIEF DESCRIPTION OF THE DRAWINGS

Some embodiments by way of example of the invention are described in more detail hereinafter by means of schematic drawings, wherein

FIG. 1 shows a first embodiment of a laser system,

FIG. 2 shows a second embodiment of the laser system, and

FIG. 3 shows a microscope comprising the laser system.

Components with the same construction or function have been given the same reference numerals in different Figures.

### DETAILED DESCRIPTION OF THE INVENTION

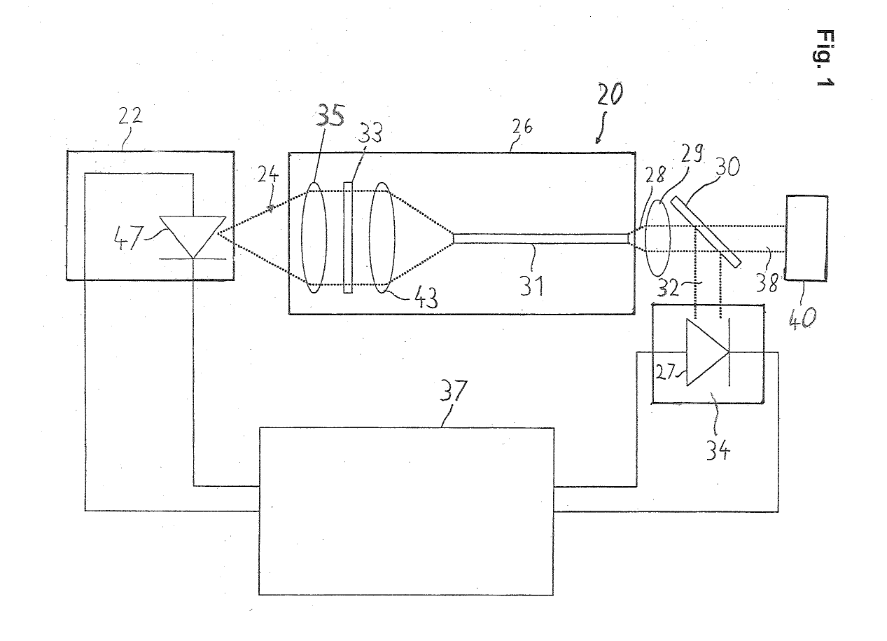

FIG. 1 shows a laser system 20 which serves particularly as a light source in a microscope, for example a confocal scanning microscope. The laser system 20 comprises a laser module 22, a beam correction device 26, a measuring element 34 and an external controller 37.

The laser module 22 produces a light beam 24. The light beam 24 passes through the beam correction device 26. The beam correction device 26 comprises two compensation elements. The compensation elements are an optical fibre 31 and a wavelength filter 33 through which the light beam 24 passes. The beam correction device 26 has an optical collimator 35. The light beam 24 is directed through the optical collimator 24 onto the wavelength filter 33. After the wavelength filter 33 the light beam 24 is directed through the optical focussing device 43 onto an axial end of the optical fibre 31 and coupled into it. A corrected light beam 28 leaves the optical fibre 31 and the beam correction device 26 at another axial end of the optical fibre 31 and strikes a lens 29. After the lens 29 the corrected light beam 28 meets a semitransparent first mirror 30, which may also be referred as a beam splitter. The first mirror 30 deflects a corrected first partial light beam 32 onto a measuring element 34 and allows a corrected second partial light beam 38 to pass through, which is then directed onto an application device 40. The measuring element 34 is electrically coupled to the external controller 37 which is in turn electrically coupled to the laser module 22. In this embodiment the application device 40 is a confocal scanning microscope.

The optical collimator 24 collimates the light beam 24 before it strikes the wavelength filter 33. The wavelength filter 33 is preferably a narrow-band band pass filter for cutting out a wavelength range of interest and is suitable for correcting any deviation of an actual value of the wavelength of the light beam 24 from a predetermined target value for the wavelength. The optical focussing device 43 focuses the light beam 24 onto the optical fibre 31, so that the light beam 24 is coupled into the optical fibre 31. The optical fibre 31 corrects any deviation of an actual value of a beam path of the light beam 24 from a predetermined target value for the beam path. In other words, after the optical fibre 31 an actual beam path of the light beam 24 corresponds at least approximately to a predetermined beam path of the light beam 24. The measuring element 34 captures an actual value for an intensity of the first partial beam 32. For this purpose the measuring element 34 comprises a photodiode 27, for example. The actual value of the intensity is then supplied to an external controller 37. The controller ensures that, for example, a laser diode 47 of the laser module 22 is supplied with energy precisely such that the actual value of the intensity approaches a target value for the intensity or corresponds to the target value for the intensity. The laser diode 47 is preferably of such dimensions as to provide a sufficient adjustment reserve.

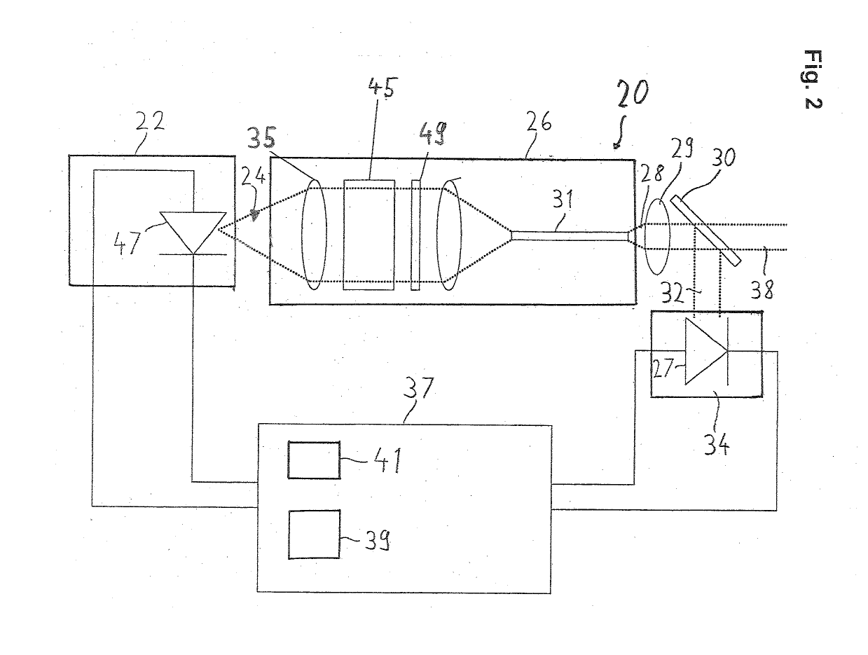

Alternatively, the beam correction device 26 may comprise more or fewer compensation elements. For example, the beam correction device 26 may comprise a diaphragm or, as explained in more detail hereinafter with reference to FIG. 2, a frequency converter 45 and/or a pole filter 49, which may be provided in addition to or instead of the wave-length filter 35. Moreover, the optical focussing device 43 and/or the optical collimator 24 may be omitted, or one or more additional optical focussing devices 43 or optical collimators 24 may be provided.

The diaphragm, which may for example be provided as an alternative or in addition to the optical fibre 31, like the optical fibre 31 ensures that the beam path of the light beam 24 after the beam correction device 26 corresponds exactly to the prescribed beam path. The pole filter 49 corrects deviations in an actual value of the polarisation of the light beam 24 from a prescribed target value for the polarisation. The provision of a pinhole, which may be provided in addition to the optical fibre 31, like the optical fibre 31 helps to ensure that actual values of the beam quality and beam position diverge as little as possible from prescribed target values for the beam quality or beam position.

The wavelength, the polarisation, the beam position and beam quality of the light beam 24 are parameters of the light beam 24. The deviations in one of the parameter values also include fluctuations in the corresponding parameter value by a different value. In particular, the term deviations also means drift effects which occur as a result of temperature changes, ageing and/or wear of the components of the laser system 20. In particular, the drift effects include changes in the efficiency of the laser diode, the wave-length spectrum of the light produced, the beam form of the light beam 24, the energy distribution within the light beam 24, the direction of the light beam 24, the quality of focussing or collimation of the light beam 24, etc.

The components of the laser system 20 work together so that the corrected light beam 38 is particularly precise and stable in its intensity. The fact that the light beam is particularly precise means that actual values for the wavelength, the polarisation, the beam position and/or beam quality preferably do not deviate, or deviate as little as possible, from corresponding target values. In other words the drift effects and/or fluctuations in the individual parameters are converted into intensity fluctuations and regulated through the emission of the laser diode 47. In this way, simple and favourable components for the laser system 20 can be used without the corrected light beam 38 losing precision and stability. Thus the laser system 20 can be manufactured particularly cheaply but still makes it possible to produce a particularly precise and stable light beam and thus enable the use of the laser system 20 in equipment in which high demands are made of the light source used.

FIG. 2 shows an embodiment of the laser system 20 having an internal controller 41. In this embodiment, instead of the wavelength filter 33, the pole filter 49 and the frequency converter 45 are provided as compensating elements in the beam correction device 26.

The internal controller 41 ensures that an actual value of the current for supplying the laser diode 47 corresponds as precisely as possible to the target value for the current. The internal controller 41 captures the actual value of the current, compares it with the target value for the current and regulates the actual value for the current to the target value of the current by means of a power supply 39 to the laser diode 47. The frequency converter 45 ensures that a frequency of the light beam 24 is converted into a prescribed frequency. For example, the frequency converter may double the frequency of the light beam 24. Alternatively, the wavelength filter 33 may additionally be provided.

The intensity of the light beam 24 which is produced by the laser diode 47, and hence of the corrected light beam 38 as well, depends among other things on the current flowing through the laser diode 47. For example, the external controller 37 prescribes a target value for the current. Moreover, the target value for the intensity of the light beam 24 may be fixedly prescribed, prescribed by the application device 40 or at least determined by the latter.

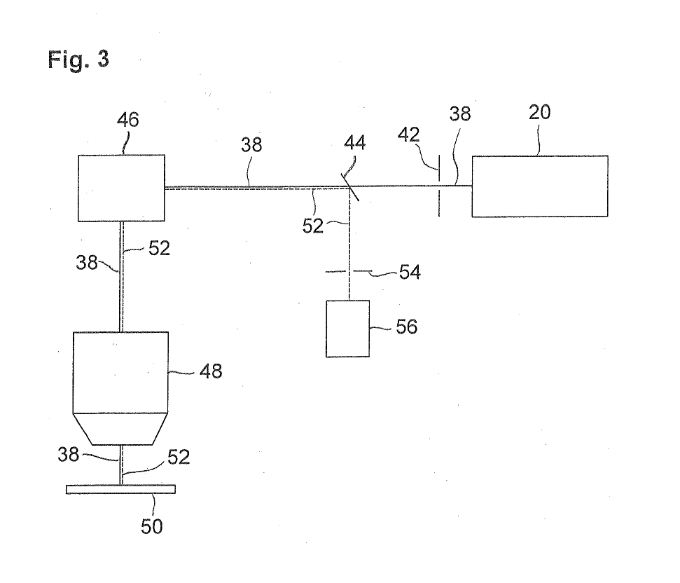

FIG. 3 shows another confocal scanning microscope which has the laser system 20 as its light source. The corrected light beam 38 is directed onto a deflector device 46 through a first diaphragm 42 and a second semitransparent mirror 44, which is preferably embodied as a dichroic beam splitter. The deflecting device is a scanning module which deflects the precise light beam 38 successively onto different areas of a specimen 50 that are to be examined, so that an area of the specimen 50 to be examined can be scanned with the precise light beam 38 according to a predetermined scanning pattern. The scanning pattern is meandering in shape. Before the precise light beam 38 is directed onto the specimen 50, it is focussed on the specimen 50 by means of another optical focussing device 48.

Alternatively or in addition to the deflecting device 46, the additional optical focussing device 48 or at least a lens of the additional optical focussing device 48 may be coupled to an actor arrangement such that the actor arrangement enables controlled movement of the lens relative to the corrected light beam 38 and/or relative to a housing of the optical focussing device 48 or the microscope housing. If the lens is moved in the plane, a focus point of the lens in the plane is also moved. Thus the scanning function for deflecting the corrected light beam 38 can be achieved by moving the optical focussing device 48 or at least the lens of the optical focussing device 48 in a plane.

A detection light beam 52 emanates from the specimen 50, which up till now, until it reaches the second mirror 44, has the same beam path as the corrected light beam 38 and which is directed onto a detector 56 by the second minor 44 through a second diaphragm 54, particularly a pinhole.

The invention is not restricted to the embodiments described. For example, the laser system 20 may be used as a light source for different pieces of equipment in which it is necessary to save costs while at the same time precise and stable light beams are particularly essential, particularly for microscopes of all kinds, especially scanning microscopes or laser scanners.

### LIST OF REFERENCE NUMERALS

20 Laser system
22 Laser module
24 Light beam
26 Beam correction device
27 Photodiode
28 Corrected light beam
29 Lens
30 First mirror
31 Optical fibre
32 Corrected first partial light beam
33 Wavelength filter
34 Measuring element
35 Optical collimator
36 Actual value intensity
38 Corrected second partial light beam
39 Power supply
40 Application device
41 Internal controller
42 First diaphragm
43 Optical focussing device
44 Second minor
46 Deflecting device
47 Laser diode
48 Further optical focussing device
49 Pole filter
50 Specimen
52 Detection light beam
54 Second diaphragm
56 Detector

1. A laser system (20) for a microscope, comprising:
a laser module (22) that generates a light beam (24);
a beam correction device (26) through which the light beam (24) passes, the beam correction device configured to correct a deviation in an actual value of at least one parameter of the light beam (24) from a predetermined target value for the at least one parameter;
an optical fibre (31) into which the corrected light beam (24) is coupled, the optical fibre (31) comprising a monomode glass fibre;
a measuring element (34) downstream of the optical fibre (31) configured to capture an actual value (36) of intensity of at least one partial beam (32) of the corrected light beam (24); and
an external controller (37) coupled to a power supply (39) of the laser module (22) and coupled to the measuring element (34), the external controller (37) configured to regulate the actual value (36) of the intensity to a prescribed target value for the intensity.

2. (canceled)

3. The laser system (20) according to claim 1, wherein the core diameter of the monomode glass fibre is in the range of the wavelength of the light beam (24).

4. The laser system (20) according to claim 1, wherein the beam correcting device (26) comprises a diaphragm, a wavelength filter (33), a pinhole and/or a pole filter (49).

5. The laser system (20) according to claim 1, wherein the laser module (22) comprises a semiconductor laser.

6. The laser system (20) according to claim 5, wherein the semiconductor laser comprises a surface-emitting or edge-emitting laser diode (47).

7. The laser system (20) according to claim 1, further comprising an internal controller (41) that regulates an actual value of the current through the laser module (22) to a target value for the current.

8. A method for operating a laser system (20) for a microscope,
wherein a light beam (24) is produced by means of a laser module (22),
a deviation of an actual value of at least one parameter of the light beam (24) from a target value for the parameter is corrected,
the corrected light beam (24) is coupled into an optical fibre (31),
an actual value (36) of an intensity of the corrected light beam (24) emerging from the optical fibre (31) is captured,
and wherein the actual value (36) of the intensity is regulated to a target value for the intensity by means of a power supply (39) to the laser module (22).

9. The method according to claim 8, wherein, depending on a control deviation between the actual value (36) and the target value for the intensity, a target value for a current flowing through the laser module (22) is prescribed and wherein an actual value of the current is captured and is regulated to the corresponding target value of the current.

10. The method according to claim 8, wherein, in order to modulate the light intensity, the target value of the intensity is dynamically prescribed.
